(19) United States
(12) Patent Application Publication
(10) Pub. No.: US 2025/0129932 A1
(43) Pub. Date: Apr. 24, 2025

(54) Light emitting fan device

(71) Applicant: Cooler Master Co., Ltd., Taipei City (TW)

(72) Inventor: Chun-Hsien Chen, Taipei City (TW)

(21) Appl. No.: 18/923,991

(22) Filed: Oct. 23, 2024

(30) Foreign Application Priority Data
Oct. 23, 2023 (TW) 112211415

(51) Int. Cl. F21V 33/00; F04D 19/00; F04D 25/06; F04D 29/00; F21V 3/04; F21V 23/00; F21Y 115/10

(52) U.S. Cl. CPC F21V 33/0096; F04D 25/0693; F04D 29/005; F21V 3/049; F21V 23/005; F04D 19/002; F21Y 2115/10

(57) ABSTRACT

A light emitting fan device may include a magnetic component, fan frame, fan assembly, decorative plate, and driving circuit board. The driving circuit board, the magnetic component and the fan assembly are disposed in the interior cavity. The decorative plate includes an identifying indicia and is coupled to the fan assembly. The fan frame includes a sensing component configured to detect a first magnetic field direction and generate a first signal and a second magnetic field direction and generate a second signal of the magnetic component. The driving circuit board includes a plurality of light sources and controller integrated circuit. The plurality of light sources emit light that is directed toward the decorative plate. The identifying indicia permits at least some light to pass therethrough. The controller integrated circuit is configured to receive the first signal and the second signal and turn “ON” and “OFF” the plurality of light sources.

### RELATED APPLICATIONS

This US application claims the benefit of priority to Taiwan application no. 112211415, filed on Oct. 23, 2023, of which is incorporated herein by reference in its entirety.

### TECHNICAL FIELD

The present disclosure relates to heat-transfer components and assemblies, and more particularly, but not limited to, light emitting fan devices.

### BACKGROUND OF THE INVENTION

With increasing processing speed and performance of electronic devices, the amount of heat generated during operation of an electronic device has increased. The heat generation increases the temperature of the electronic device and, if the heat cannot be dissipated effectively, the reliability and performance of the electronic device is reduced. To prevent overheating of an electronic device, cooling systems such as air-cooling systems and liquid cooling systems are used to efficiently dissipate the heat generated by the electronic device and, thereby ensure the standard operation of the electronic device.

In the case of fans or other rotating cooling apparatuses of air-cooling systems, the fans are commonly mounted to the electronic devices via attachment members such as screws and push pins. Lighting such as light-emitting diode (LED) lights, LED strip lights, or LED bar lights may be assembled to the fans for illumination of the fans and the electronic devices. Nonetheless, it is challenging to fix an appearance of a rotating part of a fan without adding multiple parts to the fan, which increases the amount of parts that may wear out or be damaged, or customizing the fan, which makes maintenance, repair, and parts replacement more inconvenient and costly.

### SUMMARY OF THE INVENTION

The present disclosure provides a light emitting fan device with a fixed rotating part appearance.

In some aspects, the techniques described herein relate to a light emitting fan device, including a magnetic component, a fan frame, a fan assembly, a decorative plate, and a driving circuit board. The magnetic component includes two opposing magnetic polarities. The two opposing magnetic polarities include a first magnetic pole zone including a first magnetic field direction and a second magnetic pole zone including a second magnetic field direction. The fan frame includes a base circuit board and a sensing component arranged on the base circuit board. The sensing component is configured to detect the first magnetic field direction and generate a first signal, and configured to detect the second magnetic field direction and generate a second signal. The fan assembly includes a hub and a plurality of blades radially extending from the hub. The magnetic component is coupled to an interior cavity of the hub. The fan assembly is rotatably disposed in the fan frame. The decorative plate includes an identifying indicia. The decorative plate is coupled to an exterior surface of the hub. The identifying indicia permits at least some light to pass therethrough. The driving circuit board includes a plurality of light sources and a controller integrated circuit. The driving circuit board is disposed in the interior cavity. The plurality of light sources arranged on the driving circuit board and configured to emit light that is directed toward the decorative plate. The controller integrated circuit is arranged on the driving circuit board and configured to receive the first signal and the second signal from the sensing component and configured to turn “ON” and “OFF” the plurality of light sources.

In some aspects, the techniques described herein relate to a light emitting fan device, further including a stator disposed on the base circuit board. The driving circuit board is disposed on the stator.

In some aspects, the techniques described herein relate to a light emitting fan device, wherein the magnetic component is a ring magnet. The magnetic component surrounds the driving circuit board and the stator, and the sensing component is arranged in an out-of-plane orientation on the base circuit board relative to the magnetic component.

In some aspects, the techniques described herein relate to a light emitting fan device, wherein the magnetic component is evenly divided between the first magnetic pole zone and the second magnetic pole zone.

In some aspects, the techniques described herein relate to a light emitting fan device, wherein the sensing component is a hall-effect sensor. In some aspects, the techniques described herein relate to a light emitting fan device, wherein the hall-effect sensor is a bipolar switch hall-effect integrated circuit.

In some aspects, the techniques described herein relate to a light emitting fan device, wherein when the controller integrated circuit receives the first signal, the plurality of light sources is turned “OFF” and when the controller integrated circuit receives the second signal, the plurality of light sources is turned “ON”. In some aspects, the techniques described herein relate to a light emitting fan device, wherein a time it takes for the controller integrated circuit to receive the second signal and the first signal is a period, and the plurality of light sources is turned “ON” during the period. In some aspects, the techniques described herein relate to a light emitting fan device, wherein a time that the plurality of light sources is turned “ON” is a duty cycle, and the duty cycle is less than the period.

In some aspects, the techniques described herein relate to a light emitting fan device, wherein N is a positive number and the period is equal to N times the duty cycle. In some aspects, the techniques described herein relate to a light emitting fan device, wherein N is between 1 and 4, inclusive.

In some aspects, the techniques described herein relate to a light emitting fan device, wherein the fan assembly further includes a shaft coupled to the hub opposite the decorative plate, and the fan frame further includes a driving component coupled to a base plate of the fan frame. The base circuit board is disposed on the base plate. The shaft is received in the driving component and the driving component is configured to rotate the fan assembly relative to the fan frame.

In some aspects, the techniques described herein relate to a light emitting fan device, wherein the magnetic component further includes two additional opposing magnetic polarities. The two additional opposing magnetic polarities include a third magnetic pole zone including the first magnetic field direction, and a fourth magnetic pole zone including the second magnetic field direction.

In some aspects, the techniques described herein relate to a light emitting fan device, wherein the magnetic component is evenly divided between the first magnetic pole zone, the second magnetic pole zone, the third magnetic pole zone, and the fourth magnetic pole zone. The second magnetic pole zone is between the first magnetic pole zone and the third magnetic pole zone, and the fourth magnetic pole zone is between the first magnetic pole zone and the third magnetic pole zone.

In some aspects, the techniques described herein relate to a light emitting fan device, wherein the driving circuit board further includes an angular position sensor arranged on the driving circuit board. The angular position sensor is configured to detect rotation angles of the shaft and determine angle of rotations indicating angular positions of the first magnetic pole zone, the second magnetic pole zone, the third magnetic pole zone, and the fourth magnetic pole zone, which in turn indicates angular positions of the identifying indicia. In some aspects, the techniques described herein relate to a light emitting fan device, wherein an initial angular position of the identifying indicia is 0 degrees.

In some aspects, the techniques described herein relate to a light emitting fan device, wherein the angular position sensor is further configured to generate a time period signal and a time duty cycle signal based on the angular positions of the first magnetic pole zone, the second magnetic pole zone, the third magnetic pole zone, and the fourth magnetic pole zone. The controller integrated circuit is further configured to receive the time period signal and a time duty cycle signal, and the plurality of light sources is turned “ON” and “OFF” based on the time duty cycle signal.

In some aspects, the techniques described herein relate to a light emitting fan device, wherein the decorative plate is made of light-permeable material.

In some aspects, the techniques described herein relate to a light emitting fan device, wherein the controller integrated circuit is further configured to control a stroboscopic effect of the identifying indicia during rotation of the fan assembly by turning “ON” and “OFF” the plurality of light sources. In some aspects, the techniques described herein relate to a light emitting fan device, wherein the controller integrated circuit turns “ON” and “OFF” the plurality of light sources such that the identifying indicia appears to be at rest when the identifying indicia is rotating.

### BRIEF DESCRIPTION OF DRAWINGS

Unless specified otherwise, the accompanying drawings illustrate aspects of the innovative subject matter described herein. Referring to the drawings, wherein like reference numerals indicate similar parts throughout the several views, several examples of light emitting fan devices incorporating aspects of the presently disclosed principles are illustrated by way of example, and not by way of limitation.

FIG. 1A illustrates a perspective view of a light emitting fan device, in accordance with various embodiments of the present disclosure.

FIG. 1B illustrates an exploded view of the light emitting fan device of FIGS. 1A to 1C, in accordance with various embodiments of the present disclosure.

FIG. 1C illustrates another exploded view of the light emitting fan device of FIGS. 1A to 1C, in accordance with various embodiments of the present disclosure.

FIG. 2 illustrates a perspective view of a magnetic component of the light emitting fan device of FIGS. 1A to 1C, in accordance with various embodiments of the present disclosure.

FIG. 3 illustrates a perspective view of an alternative magnetic component of the light emitting fan device of FIGS. 1A to 1C, in accordance with various embodiments of the present disclosure.

FIG. 4 illustrates a timing diagram of magnetic flux density signal relative to LED signal of the light emitting fan device of FIGS. 1A to 1C, in accordance with various embodiments of the present disclosure.

FIG. 5 illustrates an alternative timing diagram of magnetic flux density signal relative to LED signal of the light emitting fan device of FIGS. 1A to 1C, in accordance with various embodiments of the present disclosure.

FIG. 6A illustrates an initial angular position of 0 degrees of an identifying indicia of the light emitting fan device of FIGS. 1A to 1C, in accordance with various embodiments of the present disclosure.

FIG. 6B illustrates an angular position of 90 degrees of an identifying indicia of the light emitting fan device of FIGS. 1A to 1C, in accordance with various embodiments of the present disclosure.

FIG. 6C illustrates an angular position of 180 degrees of an identifying indicia of the light emitting fan device of FIGS. 1A to 1C, in accordance with various embodiments of the present disclosure.

FIG. 6D illustrates an angular position of 270 degrees of an identifying indicia of the light emitting fan device of FIGS. 1A to 1C, in accordance with various embodiments of the present disclosure.

### DETAILED DESCRIPTION

The following describes various principles related to components and assemblies for electronic devices cooling by way of reference to specific examples of light emitting fan devices, including specific arrangements and examples of fan frames and fan assemblies embodying innovative concepts. More particularly, but not exclusively, such innovative principles are described in relation to selected examples of magnetic and sensor components and controller integrated circuits and control functions, and well-known functions or constructions are not described in detail for purposes of succinctness and clarity. Nonetheless, one or more of the disclosed principles can be incorporated in various other embodiments of magnetic and sensor components and controller integrated circuits and control functions to achieve any of a variety of desired outcomes, characteristics, and/or performance criteria.

Thus, magnetic and sensor components and controller integrated circuits and control functions having attributes that are different from those specific examples discussed herein can embody one or more of the innovative principles, and can be used in applications not described herein in detail. Accordingly, embodiments of magnetic and sensor components and controller integrated circuits and control functions not described herein in detail also fall within the scope of this disclosure, as will be appreciated by those of ordinary skill in the relevant art following a review of this disclosure.

Example embodiments as disclosed herein are directed to cooling systems. The cooling system may be configured on a chassis, within a chassis, or as part of an electric or electronics system that includes heat producing electronic components to be cooled. The cooling system includes at least one light emitting fan. The light emitting fan may be coupled to the chassis, or device or apparatus of the electric or electronics system, or heat producing electronic component via a fastener (e.g., bolts, screws, an adhesive material, etc.), transporting air to the device or apparatus of the electric or electronics system, or heat producing electronic component or to an outside of the chassis or electric or electronics system.

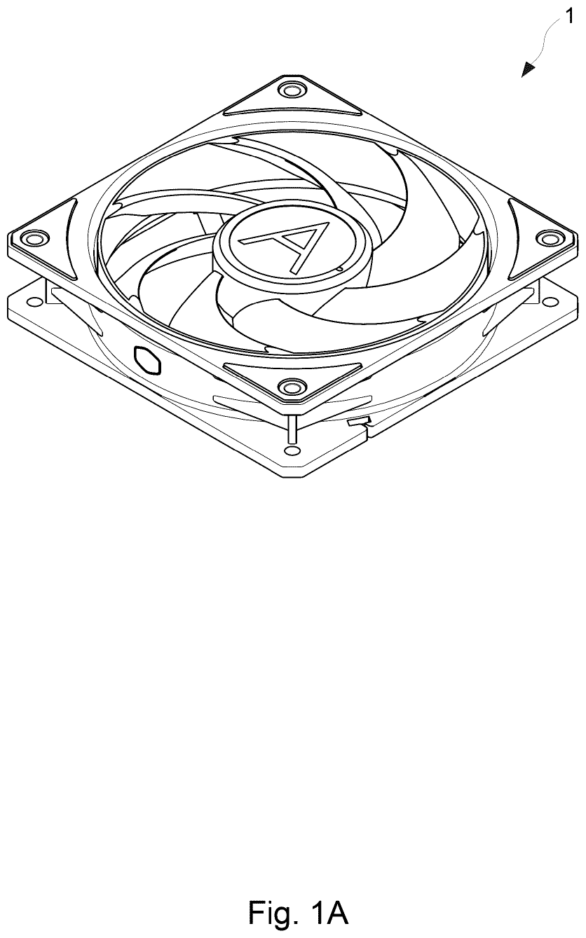

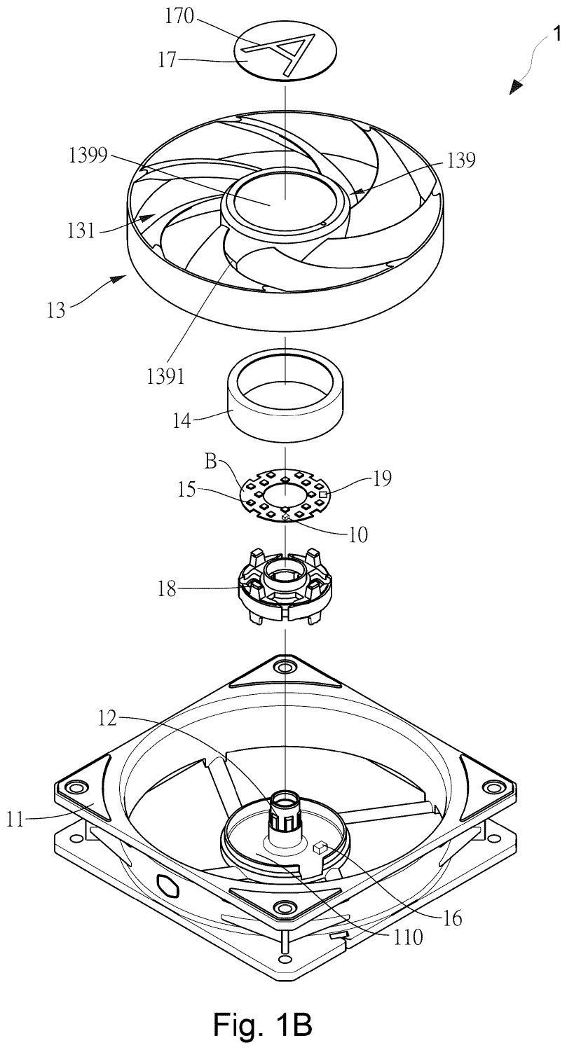

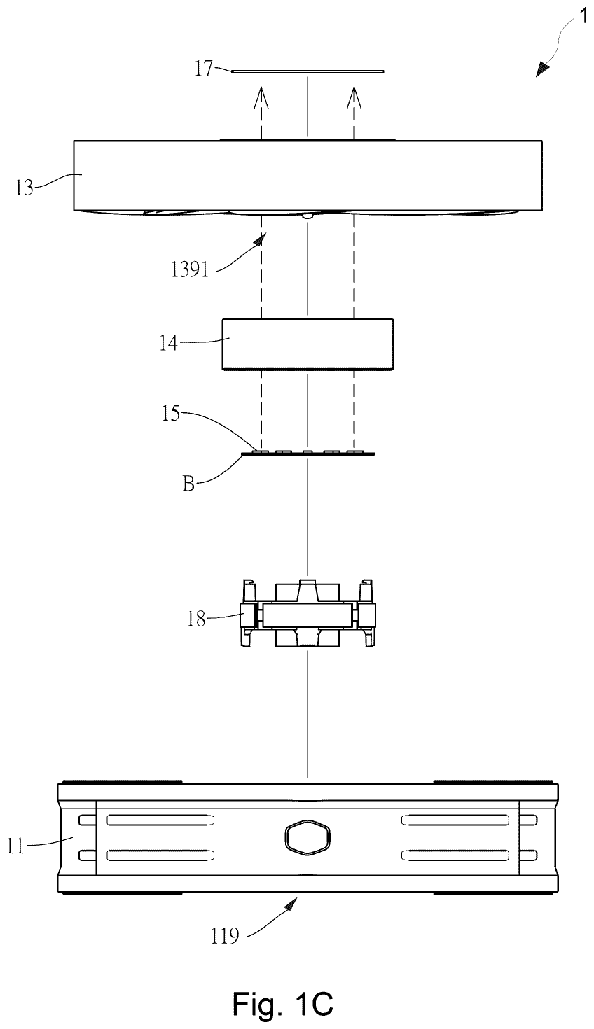

FIGS. 1A, 1B, and 1C illustrate a light emitting fan device 1, in accordance with various embodiments of the present disclosure. The light emitting fan device 1 includes a magnetic component 14, a fan frame 11, a fan assembly 13, a decorative plate 17, and a driving circuit board B. The magnetic component 14 includes two opposing magnetic polarities. The two opposing magnetic polarities include a first magnetic pole zone 141 including a first magnetic field direction and a second magnetic pole zone 142 including a second magnetic field direction. The fan frame 11 includes a base circuit board 110 and a sensing component 16 arranged on the base circuit board 110. The sensing component 16 is configured to detect the first magnetic field direction and generate a first signal T1, and configured to detect the second magnetic field direction and generate a second signal T2. The fan assembly 13 includes a hub 139 and a plurality of blades 131 radially extending from the hub 139. The magnetic component 14 is coupled to an interior cavity 1391 of the hub 139. The fan assembly 13 is rotatably disposed in the fan frame 11. The decorative plate 17 includes an identifying indicia 170. The decorative plate 17 is coupled to an exterior surface 1399 of the hub 139. The identifying indicia 170 permits at least some light to pass therethrough. The driving circuit board B includes a plurality of light sources 15 and a controller integrated circuit 19. The driving circuit board B is disposed in the interior cavity 1391. The plurality of light sources 15 is arranged on the driving circuit board B and configured to emit light that is directed toward the decorative plate 17. As an example, the plurality of light sources 15 can be a plurality of light emitting diodes. The controller integrated circuit 19 is electrically coupled to the sensing component 16 and the plurality of light sources 15. As an example, the controller integrated circuit 19 can be a processor. The controller integrated circuit 19 is arranged on the driving circuit board B and configured to receive the first signal T1 and the second signal T2 from the sensing component 16 and configured to turn “ON” and “OFF” the plurality of light sources 15.

In some embodiments, the light emitting fan device 1 further includes a stator 18 disposed on the base circuit board 110. The driving circuit board B is disposed on the stator 18. In some embodiments, the magnetic component 14 is a ring magnet. The magnetic component 14 surrounds the driving circuit board B and the stator 18, and the sensing component 16 is arranged in an out-of-plane orientation on the base circuit board 110 relative to the magnetic component 14.

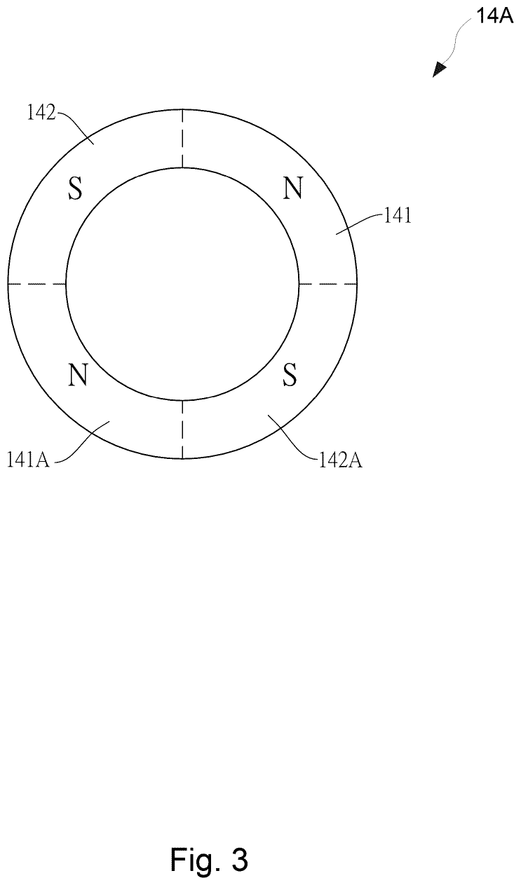

FIG. 3 illustrates a perspective view of a magnetic component 14, in accordance with various embodiments of the present disclosure. In some embodiments, the magnetic component 14 is evenly divided between the first magnetic pole zone 141 and the second magnetic pole zone 142. As an example, the first magnetic pole zone 141 can be a magnetic north pole and the second magnetic pole zone 142 can be a magnetic south pole. In some embodiments, as an example, the magnetic poles of the magnetic pole zones can be switched.

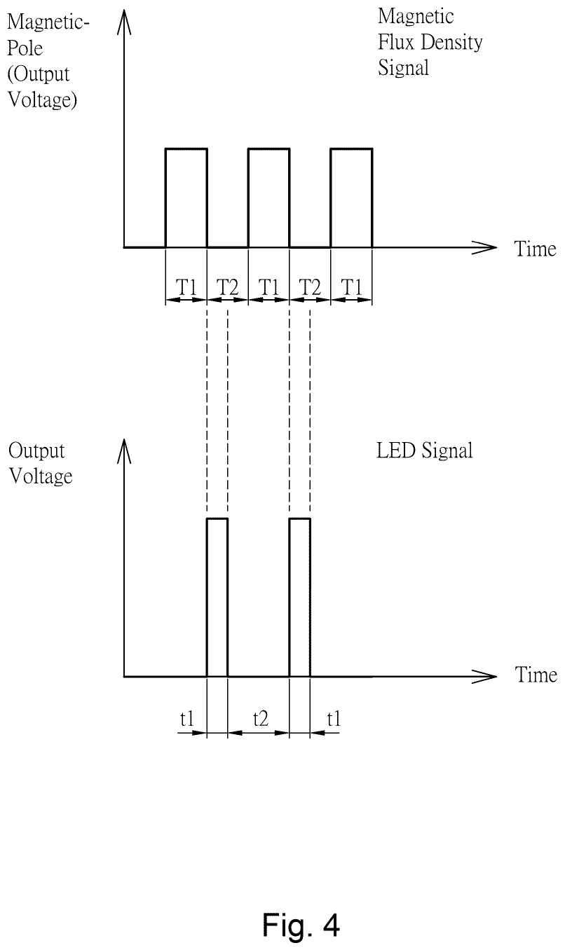

FIG. 4 illustrates a timing diagram of magnetic flux density signal relative to LED signal, in accordance with various embodiments of the present disclosure. In some embodiments, the sensing component 16 is a hall-effect sensor. In some embodiments, the hall-effect sensor is a bipolar switch hall-effect integrated circuit. As an example, the first signal T1 can be triggered by a high voltage level and the second signal T2 can be triggered by a low voltage level. The high voltage level of the first magnetic pole zone 141 and the low voltage level of the second magnetic pole zone 142 are detected by the sensing component 16 as the first magnetic pole zone 141 and the second magnetic pole zone 142 respectively rotate near to and pass the sensing component 16. In some embodiments, as an example, the triggering of the voltage levels can be switched. In some embodiments when the controller integrated circuit 19 receives the first signal (high voltage level) T1, the plurality of light sources 15 is turned “OFF” and when the controller integrated circuit 19 receives the second signal (low voltage level) T2, the plurality of light sources 15 is turned “ON”. As an example, the first signal T1 and the second signal T2 can be magnetic flux density signals of the first magnetic pole zone 141 and the second magnetic pole zone 142 of the magnetic component 14. As an example, the controller integrated circuit 19 can generate an “ON” LED signal t1 after receiving the second signal T2 or “OFF” LED signal t2 after receiving the first signal T1 to turn “ON” or “OFF” the plurality of light sources 15. In some embodiments a time it takes for the controller integrated circuit 19 to receive the second signal T2 and the first signal T1 is a period T2-T1, and the plurality of light sources 15 is turned “ON” during the period. In some embodiments a time that the plurality of light sources 15 is turned “ON” is a duty cycle t1, and the duty cycle t1 is less than the period T2- T1. In some embodiments N is a positive number and the period T2-T1 is equal to N times the duty cycle t1. Thus, in the example, N is equal to 1. In some embodiments N is between 1 and 4, inclusive.

In some embodiments, the fan assembly 13 further includes a shaft (not shown) coupled to the hub 139 opposite the decorative plate 17, and the fan frame 11 further includes a driving component 12 coupled to a base plate 119 of the fan frame 11. The controller integrated circuit 19 is further electrically coupled to the driving component 12. As an example, the driving component 12 can be a motor. The base circuit board 110 is disposed on the base plate 119. The shaft is received in the driving component 12 and the driving component 12 is configured to rotate the fan assembly 13 relative to the fan frame 11, which in turn rotates the magnetic component 14 and the identifying indicia 170.

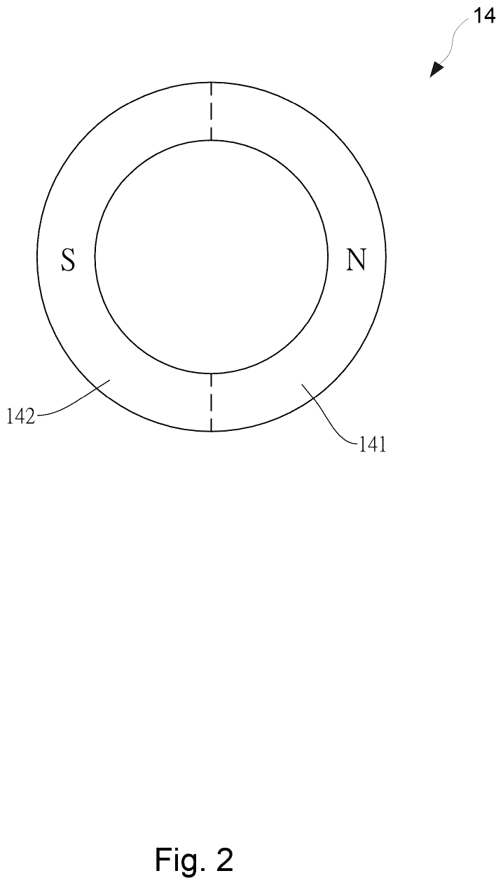

FIG. 3 illustrates a perspective view of an alternative magnetic component 14A, in accordance with various embodiments of the present disclosure. The alternative magnetic component 14A can be similar in some respects to the magnetic component 14 of FIG. 2, and therefore may be best understood with reference thereto where like numerals designate like components not described again in detail. One difference between the alternative magnetic component 14A and the magnetic component 14 is that the alternative magnetic component 14A further includes two additional opposing magnetic polarities. In some embodiments, the alternative magnetic component 14A can further include two sets of the two additional opposing magnetic polarities or in some embodiments, the magnetic component 14 can further include three sets of the two additional opposing magnetic polarities. The two additional opposing magnetic polarities include a third magnetic pole zone 141A including the first magnetic field direction, and a fourth magnetic pole zone 142A including the second magnetic field direction. In some embodiments, the magnetic component 14 is evenly divided between the first magnetic pole zone 141, the second magnetic pole zone 142, the third magnetic pole zone 141A, and the fourth magnetic pole zone 142A. The second magnetic pole zone 142 is between the first magnetic pole zone 141 and the third magnetic pole zone 141A, and the fourth magnetic pole zone 142A is between the first magnetic pole zone 141 and the third magnetic pole zone 141A. As an example, in addition to the first signal T1 being triggered by a high voltage level and the second signal T2 being triggered by a low voltage level, the first signal T1 is also triggered by a high voltage level of the third magnetic pole zone 141A and the second signal T2 is also triggered by a low voltage level of the fourth magnetic pole zone 142A. The high voltage level of the first magnetic pole zone 141 and the low voltage level of the second magnetic pole zone 142 and the high voltage level of the third magnetic pole zone 141A and the low voltage level of the second magnetic pole zone 142 are detected by the sensing component 16 as the first magnetic pole zone 141, the second magnetic pole zone 142, the third magnetic pole zone 141A and the fourth magnetic pole zone 142A respectively rotate near to and pass the sensing component 16. Another difference between the alternative magnetic component 14 and the magnetic component 14 is the conditions to which the controller integrated circuit 19 turns “ON” and “OFF” the plurality of light sources 15.

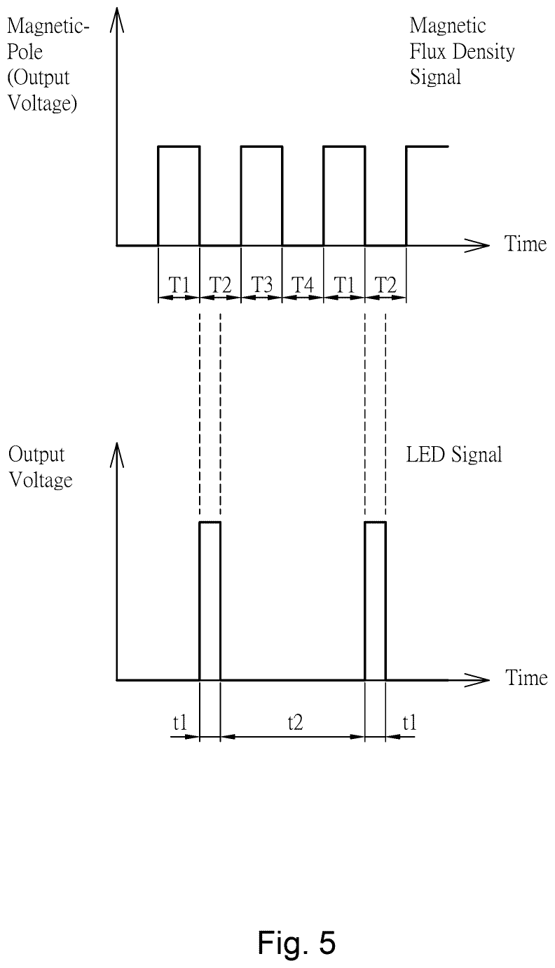

FIG. 5 illustrates an alternative timing diagram of magnetic flux density signal relative to LED signal, in accordance with various embodiments of the present disclosure. As an example, the first signal T1, the second signal T2, a second first signal T3, and a second second signal T4, can be magnetic flux density signals of the first magnetic pole zone 141, the second magnetic pole zone 142, the third magnetic pole zone 141A, and the fourth magnetic pole zone 142A of the magnetic component 14. In some embodiments when the controller integrated circuit 19 receives each first signal (high voltage level) T1 and T3, the plurality of light sources 15 is not turned “OFF”. The controller integrated circuit 19 generates an “OFF” LED signal to turn “OFF” the plurality of light sources 15 when the first signal T1 or the second first signal T3 of the two first signals is received by the controller integrated circuit 19. As an example, when the controller integrated circuit 19 receives the second second signal T4, the first signal T1, the second signal T2, and the second first signal T3, then the controller integrated circuit 19 generates an “OFF” LED signal to turn “OFF” the plurality of light sources 15. In some embodiments, when the controller integrated circuit 19 receives each second signal (low voltage level) T2 and T4, the plurality of light sources 15 is not turned “ON”. The controller integrated circuit 19 generates an “ON” LED signal to turn “ON” the plurality of light sources 15 when the second signal T2 or the second second signal T4 of the two second signals is received by the controller integrated circuit 19. As an example, when the controller integrated circuit 19 receives the second first signal T3, the second second signal T4, the first signal T1, and the second signal T2, then the controller integrated circuit 19 generates an “ON” LED signal t1 to turn “ON” the plurality of light sources 15. Thus, in the example, N is equal to 2.

In some embodiments, the driving circuit board B further includes an angular position sensor 10 arranged on the driving circuit board B. The angular position sensor 10 is electrically coupled to the controller integrated circuit 19 and the driving component 12. The angular position sensor 10 is configured to detect rotation angles of the shaft and determine angle of rotations indicating angular positions of the first magnetic pole zone 141, the second magnetic pole zone 142, the third magnetic pole zone 141A, and the fourth magnetic pole zone 142A, which in turn indicates angular positions of the identifying indicia 170.

In some embodiments, the angular position sensor 10 is further configured to generate a time period signal and a time duty cycle signal based on the angular positions of the first magnetic pole zone 141, the second magnetic pole zone 142, the third magnetic pole zone 141A, and the fourth magnetic pole zone 142A. The controller integrated circuit 19 is further configured to receive the time period signal and a time duty cycle signal, and the plurality of light sources 15 is turned “ON” and “OFF” based on the time duty cycle signal.

In some embodiments, the decorative plate 17 is made of light-permeable material. The light-permeable material can be any light-permeable material such as transparent acrylic. As an example, the identifying indicia 170 can be formed by applying a coating to the decorative plate 17. A mask and a sputtering process can be used for the coating to form the identifying indicia 170. The identifying indicia 170 can be any identifying indica such as a brand name, a brand logo, or a marking. In some embodiments, the identifying indicia 170 comprises an “UP” and “DOWN” position when at rest (not rotating).

In some embodiments, the controller integrated circuit 19 is further configured to control a stroboscopic effect of the identifying indicia 170 during rotation of the fan assembly 13 by turning “ON” and “OFF” the plurality of light sources 15. In some embodiments, the controller integrated circuit 19 turns “ON” and “OFF” the plurality of light sources 15 such that the identifying indicia 170 appears to be at rest when the identifying indicia 170 is rotating.

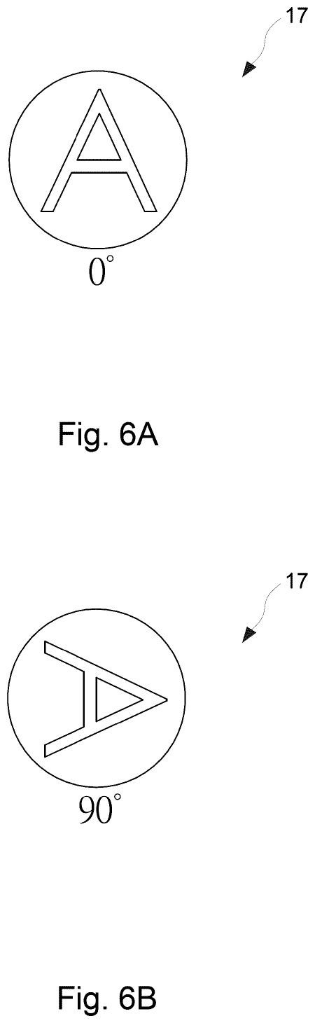

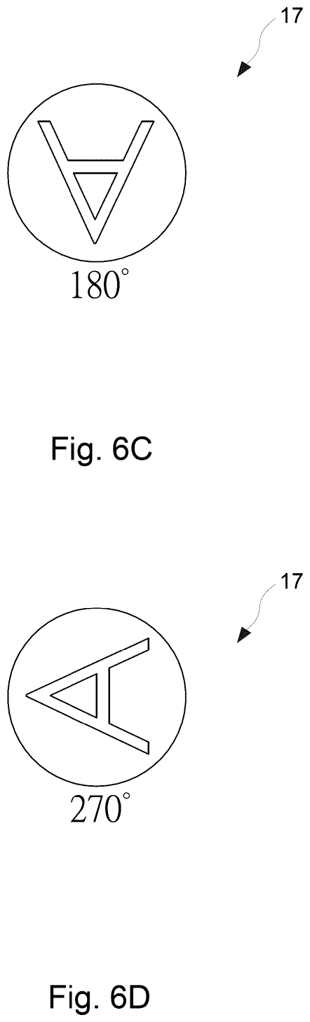

FIGS. 6A, 6B, 6C, and 6D illustrate angular positions of an identifying indicia 170, in accordance with various embodiments of the present disclosure. As an example, the identifying indicia 170 is the letter “A” and “A” is in the “UP” position, which is an initial angular position. In some embodiments, the initial angular position of the identifying indicia 170 is 0 degrees as illustrated in FIG. 6A. In some embodiments, the initial angular position of the identifying indicia 170 is not 0 degrees. As an example, when detection of the second magnetic field direction of the second magnetic pole zone 142 of the magnetic component 14 by the sensing component 16 is equal to the “UP” initial angular position at 0 degrees of the identifying indicia 170, and the fan assembly 13 is rotating, which in turn rotates the magnetic component 14 and the identifying indicia 170, the controller integrated circuit 19 will receive the second signal T2 from the sensing component 16. When the controller integrated circuit 19 receives the second signal T2, the controller integrated circuit 19 generates the “ON” LED signal t1 to turn “ON” the plurality of light sources 15. Thus, the emitted light from the plurality of light sources 15 directed toward the decorative plate 17 passing through the identifying indicia 170 will illuminate the letter “A” as being in the “UP” initial angular position. When detection of the first magnetic field direction of the first magnetic pole zone 141 of the magnetic component 14 by the sensing component 16 is equal to an angular position of the identifying indicia 170 not being 0 degrees, and the fan assembly 13 is rotating, the controller integrated circuit 19 will receive the first signal T1 from the sensing component 16. When the controller integrated circuit 19 receives the first signal T1, the controller integrated circuit 19 generates the “OFF” LED signal t2 to turn “OFF” the plurality of light sources 15. Thus, the emitted light from the plurality of light sources 15 will be “OFF” and not illuminate the letter “A”. When the sensing component 16 once again detects the second magnetic field direction of the second magnetic pole zone 142 of the magnetic component 14, the controller integrated circuit 19 will again receive the second signal T2 from the sensing component 16 and generate the “ON” LED signal t1 to turn “ON” the plurality of light sources 15 to start the process once again. Thus, stroboscopic effect of the identifying indicia 170 during rotation of the fan assembly 13 by turning “ON” and “OFF” the plurality of light sources 15 can be performed such that the identifying indicia 170 appears to be at rest when the identifying indicia 170 is rotating.

As an alternative example, when detection of the second magnetic field direction of the second magnetic pole zone 142 of the magnetic component 14 by the sensing component 16 is equal to the “UP” initial angular position at 0 degrees of the identifying indicia 170, and the fan assembly 13 is rotating, which in turn rotates the magnetic component 14 and the identifying indicia 170, the controller integrated circuit 19 will receive the second signal T2 from the sensing component 16. When the controller integrated circuit 19 receives the second signal T2, the controller integrated circuit 19 generates the “ON” LED signal t1 to turn “ON” the plurality of light sources 15. Thus, the emitted light from the plurality of light sources 15 directed toward the decorative plate 17 passing through the identifying indicia 170 will illuminate the letter “A” as being in the “UP” initial angular position. When detection of the first magnetic field direction of the third magnetic pole zone 141A, detection of the second magnetic field direction of the fourth magnetic pole zone 142A, and detection of the first magnetic field direction of the second magnetic pole zone 142 by the sensing component 16 is equal to an angular position of the identifying indicia 170 not being 0 degrees, as an example, the angular position of the identifying indicia 170 is at 90 degrees (detection of the first magnetic field direction of the third magnetic pole zone 141A), 180 degrees (detection of the second magnetic field direction of the fourth magnetic pole zone 142A), and 270 degrees (detection of the first magnetic field direction of the first magnetic pole zone 141) as respectively illustrated in FIGS. 5, 6B, 6C, and 6D, and the fan assembly 13 is rotating, the controller integrated circuit 19 will respectively receive the second second signal T4, the first signal T1, the second signal T2 and the second first signal T3. When the controller integrated circuit 19 receives the second first signal T3, the controller integrated circuit 19 generates the “OFF” LED signal t2 to turn “OFF” the plurality of light sources 15. Thus, the emitted light from the plurality of light sources 15 will be “OFF” and not illuminate the letter “A”. When the sensing component 16 once again detects the second signal T2, the controller integrated circuit 19 will again receive the second signal T2 from the sensing component 16 and generate the “ON” LED signal t1 to turn “ON” the plurality of light sources 15 to start the process once again. Thus, stroboscopic effect of the identifying indicia 170 during rotation of the fan assembly 13 by turning “ON” and “OFF” the plurality of light sources 15 is performed such that the identifying indicia 170 appears to be at rest when the identifying indicia 170 is rotating.

In some embodiments, when the light emitting fan device 1 is turned off, the controller integrated circuit 19 turns off the fan device when the second signal T2 is received from the sensing component 16. Thus, the identifying indicia 170, as an example, the letter “A”, will stop at the initial angular position of 0 degrees every time the light emitting fan device 1 is stopped.

A light emitting fan device 1 having a stroboscopic effect of an identifying indicia 170 during rotation of the fan assembly 13 is provided. The magnetic component 14 can be divided into different magnetic pole zones, whereby the sensing component 16 detects magnetic field directions of each magnetic pole zone and respectively generates a first signal T1, second signal T2, second first signal T3, or second second signal T4, etc. The controller integrated circuit 19 receives each first signal (high voltage level) T1 and T3 and can determine when to turn the plurality of light sources 15 “OFF”. The controller integrated circuit 19 receives each second signal (low voltage level) T2 and T4 and can determine when to turn the plurality of light sources 15 “ON”. Moreover, the angular position sensor 10 can be added to generate a time period signal and a time duty cycle signal based on the angular positions of the first magnetic pole zone 141, the second magnetic pole zone 142, the third magnetic pole zone 141A, and the fourth magnetic pole zone 142A. The controller integrated circuit 19 receives the time period signal and time duty cycle signal from the angular position sensor 10 to turn the plurality of light sources 15 “ON” or “OFF”. The magnetic component 14 and the sensing component 16 can be used by the controller integrated circuit 19 to turn “ON” or “OFF” the plurality of light sources 15 to achieve the stroboscopic effect of the identifying indicia 170 such that when rotating, the identifying indicia 170 appears to be at a fixed position. The magnetic component 14, the sensing component 16, and the angular position sensor 10 can also be used by the controller integrated circuit 19 to turn “ON” or “OFF” the plurality of light sources 15 to achieve the stroboscopic effect of the identifying indicia 170 such that when rotating, the identifying indicia 170 appears to be at a fixed position. Furthermore, the identifying indicia 170 can appear to remain at the initial angular position when the light emitting fan device 1 is on and the identifying indica is rotating and can be at the initial angular position when the light emitting fan device 1 is off, as the controller integrated circuit 19 can also turn off the light emitting fan device 1 only when the second signal T2 is received from the sensing component 16. Thus, multiple or complex parts are not required to fix the appearance of the rotating identifying indicia 170, which minimizes the inconvenience and costliness of maintenance, repair, and parts replacement.

Therefore, embodiments disclosed herein are well adapted to attain the ends and advantages mentioned as well as those that are inherent therein. The particular embodiments disclosed above are illustrative only, as the embodiments disclosed may be modified and practiced in different but equivalent manners apparent to those of ordinary skill in the relevant art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some number. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces.

1. A light emitting fan device, comprising:
a magnetic component including two opposing magnetic polarities;
wherein, the two opposing magnetic polarities comprise:
a first magnetic pole zone including a first magnetic field direction; and
a second magnetic pole zone including a second magnetic field direction;
a fan frame including a base circuit board and a sensing component arranged on the base circuit board, the sensing component configured to detect the first magnetic field direction and generate a first signal, and configured to detect the second magnetic field direction and generate a second signal;
a fan assembly including a hub and a plurality of blades radially extending from the hub, the magnetic component coupled to an interior cavity of the hub, the fan assembly rotatably disposed in the fan frame;
a decorative plate including an identifying indicia, the decorative plate coupled to an exterior surface of the hub, the identifying indicia permitting at least some light to pass therethrough; and
a driving circuit board including a plurality of light sources and a controller integrated circuit, the driving circuit board disposed in the interior cavity, the plurality of light sources arranged on the driving circuit board and configured to emit light that is directed toward the decorative plate, the controller integrated circuit arranged on the driving circuit board and configured to receive the first signal and the second signal from the sensing component and configured to turn “ON” and “OFF” the plurality of light sources.

2. The light emitting fan device of claim 1, further comprising a stator disposed on the base circuit board, the driving circuit board is disposed on the stator.

3. The light emitting fan device of claim 2, wherein the magnetic component is a ring magnet, and the magnetic component surrounds the driving circuit board and the stator, and wherein the sensing component is arranged in an out-of-plane orientation on the base circuit board relative to the magnetic component.

4. The light emitting fan device of claim 1, wherein the sensing component is a hall-effect sensor.

5. The light emitting fan device of claim 4, wherein the hall-effect sensor is a bipolar switch hall-effect integrated circuit.

6. The light emitting fan device of claim 1, wherein the magnetic component is evenly divided between the first magnetic pole zone and the second magnetic pole zone.

7. The light emitting fan device of claim 1, wherein the decorative plate is made of light-permeable material.

8. The light emitting fan device of claim 1, wherein when the controller integrated circuit receives the first signal, the plurality of light sources is turned “OFF” and when the controller integrated circuit receives the second signal, the plurality of light sources is turned “ON”.

9. The light emitting fan device of claim 8, wherein a time it takes for the controller integrated circuit to receive the second signal and the first signal is a period, and the plurality of light sources is turned “ON” during the period.

10. The light emitting fan device of claim 9, wherein a time that the plurality of light sources is turned “ON” is a duty cycle, and the duty cycle is less than the period.

11. The light emitting fan device of claim 10, wherein N is a positive number and the period is equal to N times the duty cycle.

12. The light emitting fan device of claim 11, wherein N is between 1 and 4, inclusive.

13. The light emitting fan device of claim 1, wherein the fan assembly further comprises a shaft coupled to the hub opposite the decorative plate, and the fan frame further comprises a driving component coupled to a base plate of the fan frame, the base circuit board disposed on the base plate, wherein the shaft is received in the driving component and the driving component is configured to rotate the fan assembly relative to the fan frame.

14. The light emitting fan device of claim 13, wherein the magnetic component further comprise two additional opposing magnetic polarities, wherein, the two additional opposing magnetic polarities comprise a third magnetic pole zone including the first magnetic field direction, and a fourth magnetic pole zone including the second magnetic field direction.

15. The light emitting fan device of claim 14, wherein the magnetic component is evenly divided between the first magnetic pole zone, the second magnetic pole zone, the third magnetic pole zone, and the fourth magnetic pole zone, and the second magnetic pole zone is between the first magnetic pole zone and the third magnetic pole zone, and the fourth magnetic pole zone is between the first magnetic pole zone and the third magnetic pole zone.

16. The light emitting fan device of claim 14, wherein the driving circuit board further comprises an angular position sensor arranged on the driving circuit board, the angular position sensor configured to detect rotation angles of the shaft and determine angle of rotations indicating angular positions of the first magnetic pole zone, the second magnetic pole zone, the third magnetic pole zone, and the fourth magnetic pole zone, which in turn indicates angular positions of the identifying indicia.

17. The light emitting fan device of claim 16, wherein the angular position sensor is further configured to generate a time period signal and a time duty cycle signal based on the angular positions of the first magnetic pole zone, the second magnetic pole zone, the third magnetic pole zone, and the fourth magnetic pole zone, and wherein the controller integrated circuit is further configured to receive the time period signal and a time duty cycle signal, and the plurality of light sources is turned “ON” and “OFF” based on the time duty cycle signal.

18. The light emitting fan device of claim 16, wherein an initial angular position of the identifying indicia is 0 degrees.

19. The light emitting fan device of claim 1, wherein the controller integrated circuit is further configured to control a stroboscopic effect of the identifying indicia during rotation of the fan assembly by turning “ON” and “OFF” the plurality of light sources.

20. The light emitting fan device of claim 19, wherein the controller integrated circuit turns “ON” and “OFF” the plurality of light sources such that the identifying indicia appears to be at rest when the identifying indicia is rotating.
